(19) United States
(12) Patent Application Publication
(10) Pub. No.: US 2008/0162840 A1
(43) Pub. Date: Jul. 3, 2008

(54) METHODS AND INFRASTRUCTURE FOR PERFORMING REPETITIVE DATA PROTECTION AND A CORRESPONDING RESTORE OF DATA

(76) Inventor: Oliver Augenstein, Dettenhausen (DE)

Correspondence Address: IBM CORPORATION;INTELLECTUAL PROPERTY LAW, 11400 BURNET ROAD, AUSTIN, TX, 78758, US

(21) Appl. No.: 11/619,206

(22) Filed: Jan. 3, 2007

(51) Int. Cl. G06F 12/00

(52) U.S. Cl. 711/161; 711/E12.103

(57) ABSTRACT

According to the present invention methods and an infrastructure are provided for performing repetitive data protection and a corresponding restore of data for block oriented data objects comprising several indexed segments.

For implementing the invention, timestamps tₖ are set by a time k; and only the first data modification of a segment is recorded, after a timestamp tₖ has been set, by storing the old data contents of said segment together with the segment index i an said timestamp tₖ as undo-log block in a journal, first, before overwriting said segment with the modified new data. The main idea of the invention is that the undo-log blocks of the segments are distributed to N journals jₙ, wherein N>1 and n=0, . . . , N-1, such that
a) at time t_{n+(m·N)} (0≦n<N) at most m+1 undo-log blocks corresponding to the same segment are recorded in the journal j₀,
b) during the time interval [t_{k+(m·N)}, t_{(m+1)·N)} no duplicates are recorded in the union of journals j₀, . . . jₖ, (0≦k<N), and
c) an undo-log block is written to journal j_{n+(m·N)} (0<n<N) if and only if the corresponding segment was modified in time interval [t_{(n-1)+(m·N)}, t_{n+(m·N)}) for the last time before the current modification;
   wherein m=0, 1, . . . ∞ and wherein the timestamps t_{(m·N)} represent consecutive reset points.

Then, only journals j₀, . . . , jₖ are needed for a point in time restore of time r_{k+(m·N)} and all changes that were written after t_{(m+1)·N} located in journal j₀. Thus, the present invention allows to reduce the amount of data that needs to be read from the journals in order to recover the system to a given point in time.

### BACKGROUND OF THE INVENTION

1. Field of the Invention

The present invention relates to repetitive data protection for data stored in a block oriented at a object comprising several indexed segments. This technology allows to restore the data contents of block oriented data objects as it was, before given timestamps, by rolling back all changes that happened after the time specified by a timestamp from a so-called undo-log captured during regular operations of an application.

2. Description of the Related Art

Continuous Data Protection (CDP) is an emerging backup and recovery technology for block oriented data objects comprising several indexed segments. As this technology has been developed for protecting large among of coherent data, prime candidates for applying CDP are database applications. By means of the CDP technology both backup and recovery times can be reduced to seconds, wherein the density of recovery points is high.

According to a preferred implementation of CDP, every modification of data stored in the segments of a data object is recorded, by copying and writing the old data contents together with the corresponding segment index and the time of modification to an undo-log journal before writing new data to a segment. Typically, undo-log journals are not located on the same volume as the data object to be protected.

If at some point in time corrupted data has been written to the data object, the undo-log information can be used to recover this failure. Therefore, a point in time previous to the write of corrupted data is chosen. Them, all modifications recorded in the undo-log journal from this pint in time up to the current time are extracted from the undo-log journal and are written back to the corresponding segments of the data object. Via this operation nay modification that has happened after the chosen point in time is in effect undone, so that afterwards the data contents of the data object is identical to its data contents at the previous time. The mechanism, how previous points in time are restored, depends on the concrete implementation of the CDP solution. Today, many CDP solutions keep their data repository on disk and avoid sequential storage media, such as tapes.

As described above, the undo-log information generated by CDP allows to restored the data contents of a data object for any arbitrary previous point in time. Correspondingly high is the amount of undo-log data to be stored. As the amount of data, that can be stored on a storage medium, is limited, it has been proposed to reduce the number of possible recovery points. Instead of creating a continuous undo-log journal, i.e. an undo-log journal containing every single data modification, an undo-log journal is created such that only certain points in time can be recovered, as e.g. hourly or even triggered recovery points. In the context of the present invention this approach is called repetitive data protection with coarse graining. Therefore, only the first data modification of a segment after a defined recovery point has to be recorded.

Nevertheless, as long as undo-log data is captured the size of the undo-log journal is growing also in case of repetitive data protection. Thus, at some point in time the undo-log reporting cannot continue. This problem can be overcome by deleting the “oldest” part of the undo-log journal and by using the free space, thus created, to continue writing the undo-log information. If this approach is chosen, the latest point in time, that can possible by restored, cannot be preserved. In fact, the widow of time that can be restored with this technique is roughly speaking proportional to the maximum possible size of the undo-log journal. A current approach suggests to copy the “oldest” part of the undo-log journal to tape before deleting it locally and to consistently manage both data sources.

If the journal containing the undo log is located on tape, the amount of time needed to restore to a certain recovery point is roughly speaking proportional to the size of the undo-log journal. If for instance an application is constantly modifying the data of exactly one and the same segment all fist modifications after consecutive recovery points are documented in the undo-log journal. Since it is difficult to identify duplicate undo-log blocks, a typical restore is applying all this undo-log information in reverse order, even if it would have been sufficient to apply only one single undo-log block, namely the first one written after the chosen recovery point. It should be mentioned here, that the impact of this problem increases the further in the past the desired recovery point resides.

### OBJECT OF THE INVENTION

Starting from this, the object of the present invention is to improve the performance of repetitive data protection, especially regarding the amount of time necessary for restore.

### BRIEF SUMMARY OF THE INVENTION

The foregoing object is achieved by methods and an infrastructure as laid out in the independent claims. Further advantageous embodiments of the present invention are described in the subsclaims and are taught in the following description.

The present invention provides a method for performing repetitive data protection for data stored in a block oriented data object comprising several indexed segments. According to this method timestamps tₖ are set by a timer k. These timestamps tₖ represent recovery points. Only the first data modification of a segment is recorded, after a timestamp tₖ has been set, but storing the old data contents of said segment together with the segment index i and said timestamp tₖ as undo-log block in a journal, first, before overwriting said segment with the modified new data. The method of the present invention is characterized in that the undo-log blocks of the segments are distributed to N journals jₙ, wherein N>1 and n=0, . . . , N-1, so that

a) at time t_{n+(m·N)} (0≦n<N) at most m+1 undo-log blocks corresponding to the same segment are recorded in the journal j₀,

b) during the time interval [t_{k+(m·N)}, t_{(m+1)·N)} no duplicates are recorded in the union of journals j₀, . . . jₖ, (0≦k<N), and

c) an undo-log block is written to journal j_{n+(m·N)} (0<n<N) if and only if the corresponding segment was modified in time interval [t_{(n-1)+(m·N)}, t_{n+(m·N)}) for the last time before the current modification;

wherein m=0, 1, . . . ∞ and wherein the timestamps t_{(m·N)} represent consecutive reset points.

As mentioned above, the present invention starts from the experience that in most cases it is not necessary to read and apply all undo-log information generated after the desired recovery point to restore the corresponding data contents of a data object. Thus, if it is possible to identify those undo-log blocks necessary for restoring the data contents of a data object to a certain recovery point, the number of undo-log blocks to read and to apply for restore can be reduced.

The main idea of the present invention is to identify those undo-log blocks for each recovery point, already when creating said undo-log blocks instead of identifying them only in a restore situation. Besides, the present invention proposes to use this additional information for selecting an appropriate target journal jₙ for each undo-log block, instead of simply moving all undo-log information to one single journal, e.g. one tape. According to the present invention, duplicate undo-log blocks, i.e. undo-log blocks concerning the same segment of a data object, are distributed to different journals such that they can be avoided to read at restore time. This distribution strategy supports an efficient data restore for any given recovery point, because it allows to easily identify irrelevant undo-log information for a certain recovery point on the base of the corresponding target journals.

As mentioned above, the method according to the invention comprise the setting of timestamps tₖ by a timer k. In an advantageous embodiment of this method said timer k can be incremented on request. In this case, a user has the option to trigger an event to increment the timer. Not that instead of user events the timer could also be triggered from a scheduler, for example on an hourly basis.

One major advantage of the proposed method for repetitive data protection is that sequential storage media, as e.g. tapes, can be used for storing the undo-log journals, because not only the writing but also the reading of these journals is done sequentially. Besides, it is recommended to use different storage devices for the different journals for accessing these journals concurrently in case of a restore. It might be of value to store only some of the journals on tape directly and store the other journals on disk. In this case a scheduler can migrate these journals to tape on a regular basis, for instance after each reset point. In such an environment it is of advantage to write at least journal j₀ to tape directly.

To improve the reliability and performance of the claimed method it is proposed to duplicate at least the undo-log blocks to be written to the first journal to create redundant copies and/or to distribute said undo-log blocks to several sub-journals.

In an advantageous embodiment of the claimed method a skip table is generated for each reset point t_{(m·N}. Said skip table maps a list of all possible segment indexes i to the journal jₙ to which the undo-log block corresponding to index i will be written to. It is initialized for each reset print such that it maps all possible indexes i to the journal j₀, while the skip table created at the previous reset point is deleted.

Regarding the restore of data, it is advantageous to maintain an offset-table comprising for each timestamp tₖ a list of journals jₙ together with the offset-position for writing to said journal jₙ after said timestamp tₖ. This offset-table has to be updated regularly for each timestamp tₖ. Typically the offset table is persistent, i.e. stored on disk or tape.

Beside a method for performing repetitive data protection for a block oriented data object, the present invention provides a method for restoring data of a block oriented data object by using undo-log information generated and stored as described above. To restore the data contents of such a data object as it was before a given timestamp t, it is first checked whether timestamp t is a reset point. If timestamp t is a reset point, only the first journal j₀ is read chronologically starting from timestamp t. The other journals can be omitted, because said first journal documents the data contents of all segments before the first modification after all consecutive reset points. In case that timestamp t is not a reset point, all journals jₙ are read, starting from the first undo-log block comprising said timestamp t, until the first reset point following timestamp t is reached. After said first reset point is reached, reading continues chronologically only for the first journal j₀. To omit the application of duplicate undo-log blocks, the data stored in an undo-log block read from a journal is only written to the corresponding segment of the data object, if said segment has not been re-written before, initiated by a undo-log block read before.

According to the claimed restore method described before, the first undo-log block comprising timestamp t in a journal has to be located, which is the offset-position for timestamp t in said journal. In an advantageous embodiment of the claimed method said offset-position is identified by means of an offset-table comprising for each timestamp tₖ a list of journals jₙ together with the offset-position for writing to said journal jₙ after said timestamp tₖ.

The application of duplicate undo-log blocks can easily be omitted by means of a restore table, listing the indexed i of those segments which have already been re-written.

Finally, the present invention provides an infrastructure for performing repetitive data protection and a corresponding restore of data, which is stored in a block oriented data object comprising several indexed segments. Said infrastructure comprises at least one block oriented data object, being the subject of repetitive data protection according to the invention; a timer for setting timestamps, representing consecutive recovery pints; an interceptor for holding the new data to be written to the data object until the old data to be overwritten is extracted for creating undo-log information; and a journaling component for generating undo-log blocks and writing them to a journal. According to the invention said infrastructure provides a set of N journals jₙ for storing undo-log blocks such that

a) at time t_{n+(m·N)} (0≦n<N) at most m+1 undo-log blocks corresponding to the same segment are recorded in the journal j₀,

b) during the time interval [t_{k+(m·N)}, t_{(m+1)·N}) no duplicates are recorded in the union of journals j₀, . . . jₖ, (0≦k<N), and

c) an undo-log block is written to journal j_{n+(m·N)} (0<n<N) if and only if the corresponding segment was modified in time interval |t_{(n-1)+(m·N)}, t_{n+(m·N)}) for the last time before the current modification;

wherein N>1; m=0, 1, . . . ∞ and wherein the timestamps t_{(m·N)} represent consecutive reset points.

Besides, said journaling component comprises a control unit for writing to multiple journals; for maintaining a skip table, comprising a list of segment indexes i together with that journal jₙ to which the undo-log block corresponding to index i will be written to; for maintaining an offset-table, comprising for each timestamp tₖ a list of journals jₙ together with the offset-position for writing to said journal jₙ after said timestamp tₖ; and for maintaining a restore table listing the indexes i of those segments which have already been re-written in case of restore.

In an advantageous embodiment of the claimed infrastructure at least the first journal to be written, which usually is the largest journal, comprises several sub-journals.

### BRIEF DESCRIPTION OF THE SEVERAL VIEW OF THE DRAWINGS

The above, as well as additional objectives, features and advantages of the present invention, will be apparent in the following detailed written description.

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 shows a backup-restore system, as it is state of the art and starting point for the present invention;

FIG. 2 shows that part of a backup-restore system, as illustrated in FIG. 1, which has been modified according to the present invention;

FIG. 3 shows a flowchart illustrating the method for performing repetitive data protection according to the present invention;

FIG. 4 shows a diagram illustrating the data structure of the undo-log journals generated according to the present invention; and

FIG. 5 shows a flowchart illustrating a method for restoring data according to the present invention;

FIG. 6 shows an advantageous variation of the backup-restore system illustrated in FIG. 2.

### DETAILED DESCRIPTION OF THE INVENTION

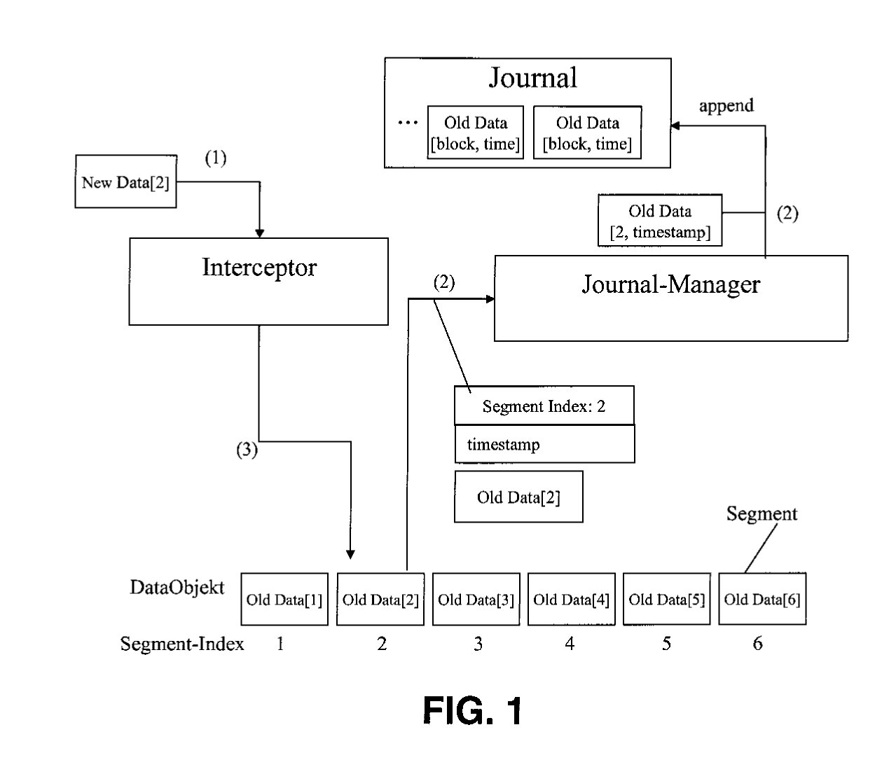

The infrastructure shown in FIG. 1 represents the state of the art for performing repetitive data protection and a corresponding restore of data, which is stored in a block oriented data object. It is discussed in the following to explain the context of the invention and to point out the differences between the state of the art and the solution proposed by the invention.

As already mentioned above, this backup-restore system comprises a block oriented Data Object with Several indexed Segments, which i subject of the repetitive data protection. The actual contents of the indexed segments is referred to as Old Data(i). FIG. 1 illustrates the situation that New Data shall be written to Segment 2. Therefor, New Data(2) is, first, transmitted to an Interceptor, where it is held until the Old Data(2) to be overwritten is extracted and transmitted to a Journal-Manager. Only then, Segment 2 is overwritten with New Data(2). The Journal-Manager creates an undo-log block on the base of Old Data(2) and the Segment-Index 2, received from the Interceptor, and a timestamp, received from a timer, which is not explicitly shown in FIG. 1. Then, the Journal-Manager appends this undo-log block to a sequential Journal.

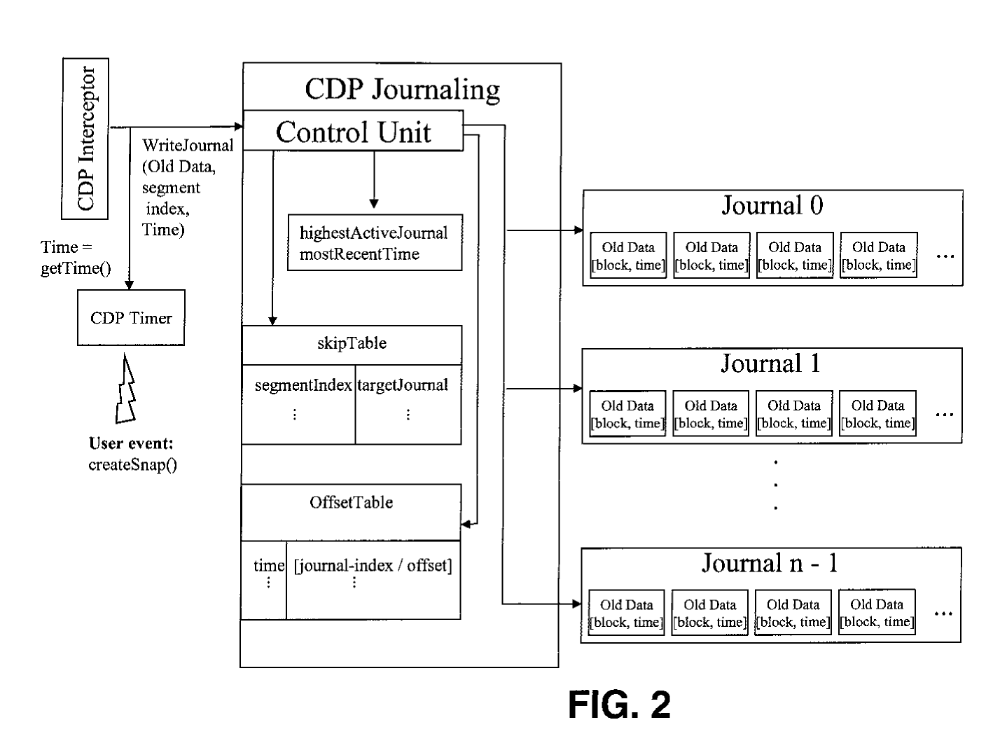

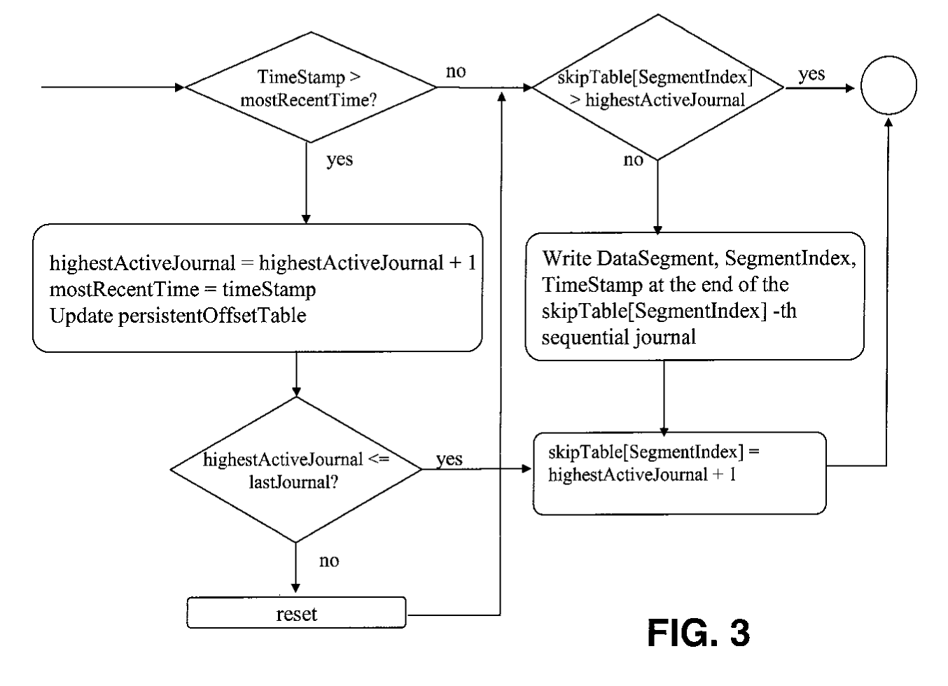

The main difference between the state of the art as described above and the invention concerns the undo-log Journal and the Journal-Manager. That is the reason by these aspects are depicted in FIG. 2. Instead of providing only one journal for storing undo-log blocks of segments which have been modified, a set of N Journals jₙ is provided according to the invention. The method how to distribute the undo-log blocks to the N different journals jₙ will be described in detail in connection with FIG. 3. Besides, the Journal-Manager has been replaced by a Journaling Component which is capable of writing to multiple Journals, each of which potentially being sequential in this embodiment of the invention. Therefor, the journaling Component comprises a Control Unit. In addition, this Control Unit maintains an OffsetTable, comprising for each timestamp tₖ a list of journals jₙ together with the offset-position for writing to said journal jₙ after said timestamp tₖ. this means, the OffsetTable comprises for each timestamp tₖ N offset entries, one for each journal. If a journal does not host any undo-log block for a certain timestamp the corresponding offset value is NONE. Thus, the OffsetTable allows to quickly locate all those positions within the journals at which the timestamp of the undo-log blocks changes its value. Beside the OffsetTable the Control Unit maintains a skipTable, comprising a list of segment indexes i together with that journal jₙ to which the next undo-log block corresponding to the indexed segment i is written to. Depending on the information collected in said skipTable, the Control Unit redirects write requests to one of the journals or discards the write. It does so in such a way that only the first k journals are needed in order to rollback to the k-th timestamp tₖ after a reset point, and that those journals do not contain any duplicate undo-log blocks.

In the embodiment illustrated in FIG. 2 the Timer is incremented only on request. Thus, a user or a secondary event generator can trigger an event to increment the timer. If the Timer receives this event is increments the internal timestamp tₖ and returns the new, higher timestamp value tₖ₊₁ upon all succeeding calls of getTime. Consequently, only those points in tie can be recovered at which an event was fired.

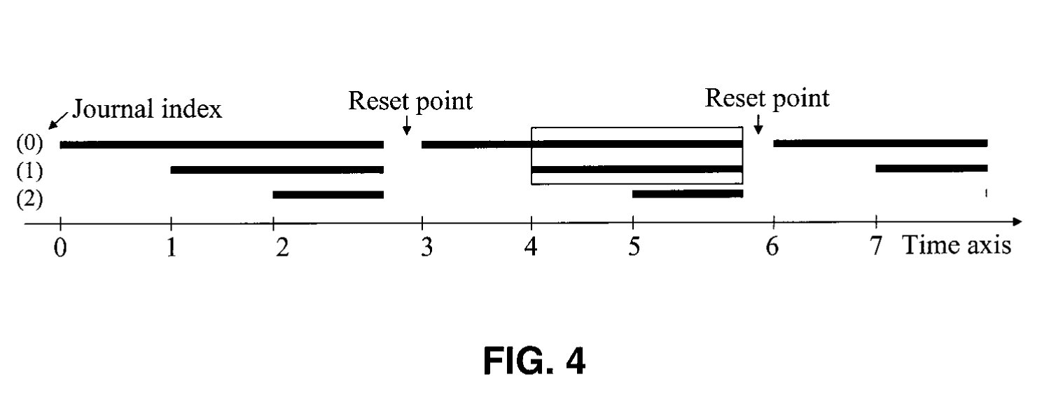

Finally, it should be mentioned that the Control Unit also maintains a restore table, what is not shown in FIG. 2. This restore Table is listing the indexes i of those segments which have already been re-written in case of restore, what will be explained in detail in connection with FIG. 4.

The flowchart of FIG. 3 illustrates the method for performing repetitive data protection according to the present invention. To initialize the algorithm variables “TimeStamp” and “mostRecentTime” are set to zero, wherein variable “TimeStamp” respresents the timestamp value provided by the Timer and variable “mostRecentTime” represents the timestamp value currently used. Initialization and reset of the algorithm comprises a reset of counter “highestActiveJournal”to zero and setting the value of “lastJournal” to N-1, wherein N is the total number of journals which shall be used. Besides, the skipTable is reset, i.e. all its values are set to zero.

In a first step “TimeStamp>mostRecentTime” the algorithm checks whether a new timestamp has been set by the Timer.

If yes, another journal shall be added to the set of active journals to be written to, by incrementing the counter “highestActiveJournal” (“highestActiveJournal=highestActiveJournal+1”. Besides, the variable “mostRecentTime” is updated (“mostRecentTime=timeStamp”) and the OffsetTable is updated as follows: For each journal (0, . . . , k), k<highestActiveJournal, the current offset within the journal is determined and stored in said OffsetTable. For the remaining journals NONE is recorded.

In a following step “highestActiveJournal<=lastJournal” the algorithm checks, whether another journal is available to be added to the set of active journals.

If no, the current timestamp represents a reset point and a reset has to be performed as described above. Then after a reset, the algorithm continues with the same step as it continues in case of yes to the question of the preceding step and not to the question of the first step. I.e. all three alternatives meet in the question “skipTable(SegmentIndex)>highestActiveJournal”. In this step the algorithm checks whether the data modification of a segment is the first after the current timestamp, so that an undo-log block has to be created and stored, or whether the undo-log information can be skipped. In case that skipTable(SegmentIndex)<=highestActiveJournal an undo-log block has to be generated an written to the skipTable(SegmentIndex)-th journal (Write DataSegment, SegmentIndex, TimeStamp at the end of the skipTable(SegmentIndex)-th sequential journal).

Then, before returning to the firs step of th algorithm, the skiptable is updated (skipTable(SegmentIndex)=highestActiveJournal+1).

The algorithm described here guarantees that:

Every time, data of a certain SegmentIndex is written for the first time after a TimeStamp incrementation, it is guaranteed to be written to exactly one journal.

An undo-log block that was already written after the last reset is guaranteed to be written to a journal with an index that is larger than the highestActiveJournal at which the previous undo-log bock of the same index was written.

The diagram of FIG. 4 illustrates how the undo-log blocks are distributed across multiple—here three—journals according to the invention. All undo-log blocks created after the first timestamp t₀ were written to the same journal j₀. After the second timestamp t₁ a further journal j₁ was added to the set of “active” journals. Then, the undo-log blocks created after timestamp t₁ were written either to journal j₀ or to journal j₁. Those undo-log blocks, documenting a first data modification of a segment after timestamp t₁ are either written to journal j₀ or to journal j₁. Those undo-log blocks which are associated with and index, whose corresponding data segment was never modified between the last reset point and the latest time t₁, are written to journal j₀. All other undo-log blocks are written to journal j₁. After the third timestamp t₂ again another journal j₂ was added to the set of “active” journals and the undo-log blocks created were distributed to the three journals. Those undo-log blocks which are associated with an index, whose corresponding data segment was never modified between the last reset point and the latest time t₂, are written to journal j₀. Those of the remaining undo-log blocks which are associated with an index, whose corresponding data segment was never modified between time t₁ and the latest time t₂, are written to journal j₁. All other undo-log blocks are written to journal j₂. As in this example there are only three journals for storing the undo-log blocks, the next timestamp t₃ represents a reset point where the distribution of undo-log blocks to said journals starts again. Thus, there are no duplicate undo-log blocks between two consecutive reset points in all journals jₙ. Though, duplicates have to be expected regarding the journal contents beyond consecutive reset points.

To restore the data contents to e.g. timestamp t₄, only the undo-log blocks of journals j₀ and j₁ have to be read and applied starting from timestamp t₄ up to the next reset point at timestamp t₆. Thenceforward, all relevant data modifications are stored in journal j₀, although journal j₀ comprises duplicates of undo-log blocks applied before. These duplicates have to be identified and omitted when reading journal j₀ starting from reset point t₆.

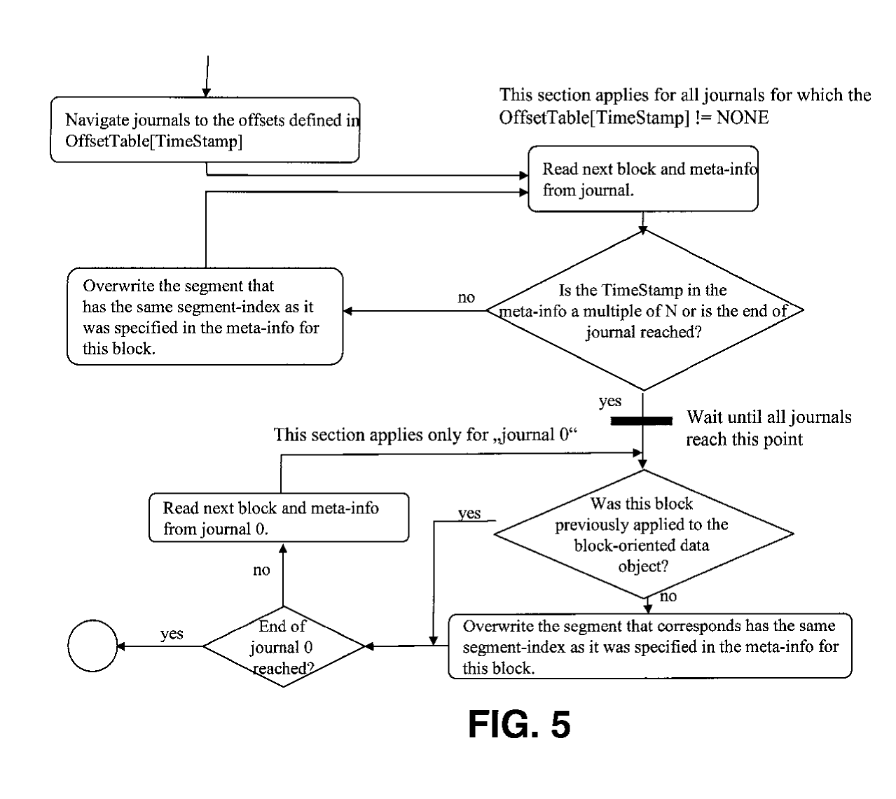

The restore of data for a given timestamp t on the base of multiple undo-log journals as described before is explained in more detail in connection with FIG. 5.

In a first step “Navigate journals to the offset defined in OffsetTable(TimeStamp)” the algorithm locates the first undo-log block written for timestamp t in each of the multiple journals. In the here described embodiment of the invention these undo-log blocks are identified by means of an offset table.

Then, the next undo-log block and especially its meta-info, i.e. the timestamp and segment index, are read from journal. The algorithm checks of reach undo-log block read “Does the TimeStamp in the metainfo correspond to a reset point or is the end of journal reached?” If not, the segment, that has the same segment-index as it was specified in the meta-info of the undo-log block read, is overwritten with the data stored in the undo-log.

This read and write operation is repeated concurrently for all relevant journals until a reset point or the end of journal is reached. Then, the algorithm continues reading and writing using only the first journal j₀. As this journal j₀ may comprise duplicate undo-log blocks, the algorithm checks “Was this block previously applied to the block-oriented data object?” and performs a write only if no.

As outlined in connection with FIG. 4, the idea behind this algorithm is to start the restore using all data streams until the first consecutive reset point is reached. Up to this reset point the undo-log blocks are distributed to the N journals such that no duplicates can occur. So, the data can be rolled back with concurrently running sessions. Thenceforward, the remaining data modifications can be rolled back using only the first journal. However, after the first consecutive reset point duplicate undo-log blocks may occur in said first journal. All those duplicates have to be ignored.

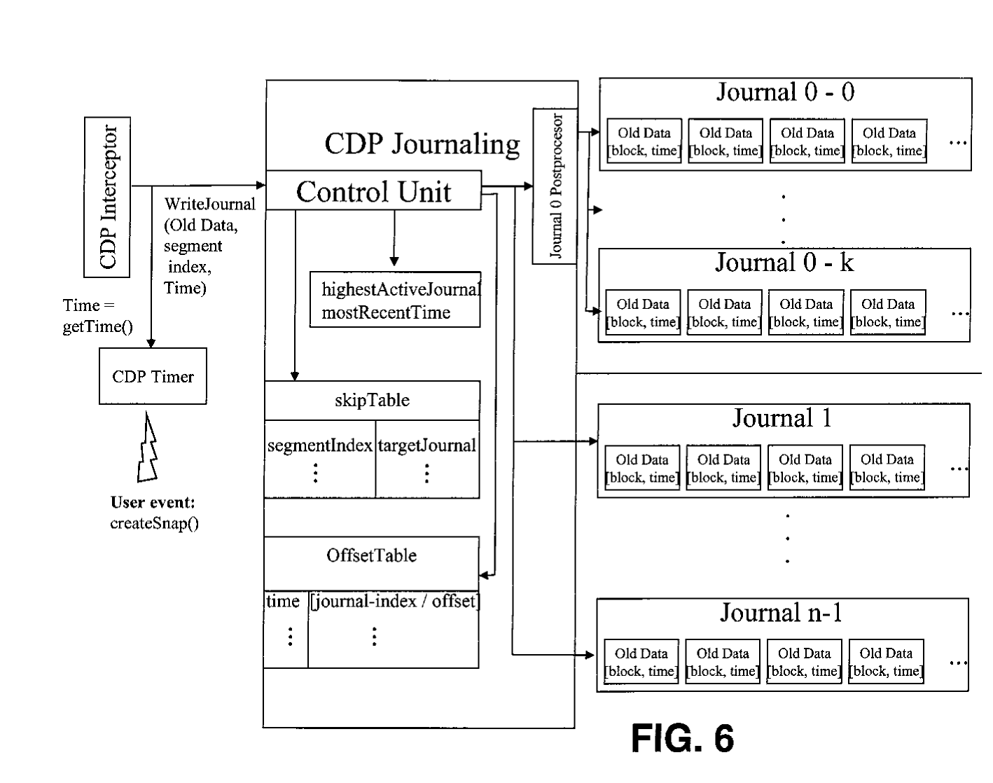

As mentioned above, it is possible to post-process the undo-log blocks created, before writing them to their target journal. FIG. 6 illustrates an infrastructure which is configured like the infrastructure shown in FIG. 2 and additionally supports such a post processing. Therefore the Journaling-Component comprises a Journal 0 Postprocessor connected to the Control Unit and k+1 sub-Journals 0-0, . . . , 0-k addressable buy said Journal 0 Postprocessor. The postprocessing may comprise an algorithm for creating redundant copies. Then, in case of failures automatic switch over to another copy is possible. The postprocessing may also comprise a splitter, i.e. the data is distributed across all sub-journals in a “round-robin” kind of mechanism. At restore time the reverse round-robin mechanism will then reproduce the desired data stream.

1. A method for performing repetitive data protection for data stored in a block oriented data object comprising several indexed segments,
wherein timestamps tₖ are set by a timer k; and
wherein only the first data modification of a segment is recorded, after a timestamp tₖ has been set, by storing the old data contents of said segment together with the segment index i and said timestamp tₖ as undo-log block in a journal, first, before overwriting said segment with the modified new data;
said method being characterized in that the undo-log blocks of the segments are distributed to N journals jₙ, wherein N>1 and n=0, . . . ,N−1, so that
a) at time t_{n+(m·N)}(0≦n<N) at most m+1 undo-log blocks corresponding to the same segment are recorded in the journal j₀,
b) during the time interval [t_{k+(m·N)}, t_{(m+1)·N}) no duplicates are recorded in the union of journals j₀, . . . jₖ,(0≦k<N), and
c) an undo-log block is written to journal j_{n+(m·N)}(0≦n<N) if and only if the corresponding segment was modified in time interval [t_{(n-1)+(m·N)}, t_{n+(m·N)}) for the last time before the current modification;
wherein m=0,1, . . . ∞ and wherein the timestamps t_{(m·N)} represent consecutive reset points.

2. The method according to claim 1, wherein the timer is incremented on request.

3. The method according to claim 1, wherein at least one of said journals is stored on a sequential storage medium, especially the journal which is written first.

4. The method according to claim 1, wherein said journals are stored on different, preferably sequential, storage devices.

5. The method according to claim 1, wherein at least the undo-log blocks to be written to the first journal are post-processed to create redundant copies and/or to distribute said undo-log blocks to several sub-journals.

6. The method according to claim 1, characterized in that a skip table is generated for each reset point t_{(m·n)} and updated for each timestamp between consecutive reset points, wherein said skip table comprises a list of segment indexes together with that journal jₙ containing the next undo-log block of the indexed segment.

7. The method according to claim 1, characterized in that an offset-table is updated regularly for each timestamp tₖ, wherein said offset-table comprises for each timestamp tₖ a list of journals jₙ together with the offset-position for writing to said journal in alter said timestamp tₖ.

8. The method for restoring data of a block oriented data object comprising several indexed segments by using undo-log information generated and stored as described by claim 1,
wherein the data contents of said segments is restored as it was before a given timestamp t;
said method being characterized in that
if timestamp t is a reset point, only the first journal j₀ is read chronologically starting from timestamp t, wherein said first journal documents the data contents of all segments before the first modification after all consecutive reset points;
otherwise, all journals jₙ are read, starting from the first undo-log block comprising said timestamp t, until the first reset point following timestamp t is reached;
after said first reset point is reached, reading continues chronologically only for the first journal j₀;
and in that
the data stored in an undo-log block read from a journal is only written to the corresponding segment of the data object, if said segment has not been re-written before, initiated by an undo-log block read before.

9. The method according to claim 8, wherein the offset-position of the first undo-log block comprising timstamp t is identified by means of an offset-table comprising for each timestamp tₖ a list of journals jₙ together with the offset-position for writing to said journal jₙ after said timestamp tₖ.

10. The method according to claim 8, wherein the journals jₙ are read concurrently.

11. The method according to claim 8, wherein a restore table is generated listing the indexes i of those segments which have already been re-written.

12. A system for performing repetitive data protection and a corresponding restore of data, which is stored in a block oriented data object comprising several indexed segments, wherein the system comprises:
at least one block oriented data object,
a timer for setting timestamps;
an interceptor for holding the new data to be written to the data object until the old data to be overwritten is extracted for creating undo-log information; and
a journaling component for generating undo-log blocks and writing them to a journal;
said infrastructure being characterized in that it provides a set of N journals jfor storing undo-log blocks of segments such that
a) at time t_{n+(m·N)}(0≦n<N) at most mid undo-log blocks corresponding to the same segment are recorded in the journal j₀,
b)during the time interval [t_{k+(m·N)}, t_{(m+1)·N}) no duplicates are recorded in the union of journals j₀, . . . jₖ, (0≦k<N), and
c) an undo-log block is written to journal j_{n+(m·N)}(0≦n<N) if and only if the corresponding segment was modified in time interval [t_{(n-1)+(m·N)}, t_{n+(m·N)}) for the last time before the current modification;
wherein N>1;m=0,1, . . . ∞ and wherein the timestamps t_{(m·n)} represent consecutive reset points; and in that said journaling component comprises a control unit for
writing to multiple journals,
maintaining a skip table, comprising a list of segment indexes i together with that journal jₙ to which the next undo-log block associated with the indexed segment is written to,
maintaining an offset-table, comprising for each timestamp tₖ a list of journals jₙ together with the offset-position for writing to said journal jₙ after said timestamp tₖ, and
maintaining a restore table listing the indexes i of those segments which have already been re-written in case of restore.

13. The system according to claim 12, wherein at least one journal, especially the first journal to be written, comprises several sub-journals.

14. A computer program product in a computer usable medium, for performing repetitive data protection for data stored in a block oriented data object comprising several indexed segments, comprising:
means for providing timestamps tₖ
means for recording a first data modification of a segment, after a timestamp tₖ has been set, by storing the old data contents of said segment together with the segment index i and said timestamp tₖ as undo-log block in a journal, first, before overwriting said segment with the modified new data;
means for distributing the undo-log blocks of the segments are distributed to N journals jₙ, wherein N>1 and n=0, . . . N−1, so that
a) at time t_{n+(m·N)}(0≦n<N) at most m−1 undo-log blocks corresponding to the same segment are recorded in the journal j₀.
b) during the time interval [t_{k+(m·N)}, t_{(m+1)·N}) no duplicates are recorded in the union of journals j₀, . . . jₖ, (0≦k>N), and
c) an undo-log block is written to journal j_{n+(m·N)}(0≦n>N) if and only if the corresponding segment was modified in time interval [t_{(n-1)+(m·N)}, t_{n+(m·N)}) for the last time before the current modification;
wherein m=0, 1, . . . ∞ and wherein the timestamps t_{(m·N)} represent consecutive reset points.
